(19) United States
(12) Patent Application Publication
(10) Pub. No.: US 2021/0100078 A1
(43) Pub. Date: Apr. 1, 2021

(54) VENTILATION-FAN-EQUIPPED MICROWAVE OVEN, AND COOKING SYSTEM

(71) Applicant: SHARP KABUSHIKI KAISHA, Sakai City (JP)

(72) Inventor: YASUHIKO KAMII, Sakai City (JP)

(21) Appl. No.: 16/326,644

(22) PCT Filed: Feb. 6, 2017
(86) PCT No.: PCT/JP2017/004236

§ 371 Date: Feb. 19, 2019

(30) Foreign Application Priority Data
Oct. 12, 2016 (JP) 2016-201182

(51) Int. Cl. H05B 6/64

(52) U.S. Cl. CPC H05B 6/6455; H05B 6/6473

(57) ABSTRACT

A ventilation fan-equipped microwave oven includes a housing to be disposed above a cooking cabinet, a main body disposed in the housing, an intake port provided on a lower side of the housing, a duct disposed in the housing, the duct leading from the intake port to a discharge port, a ventilation fan disposed in the housing to cause air sucked through the intake port to circulate though the duct and be discharged outside through the discharge port, an infrared sensor disposed on the lower side of the housing to detect temperatures of an object on the cooking cabinet, and a control unit configured to control the ventilation fan based on the temperatures, detected by the infrared sensor, of the object on the cooking cabinet.

### TECHNICAL FIELD

The present invention relates to ventilation fan-equipped microwave ovens, and cooking systems.

### BACKGROUND ART

A conventional ventilation fan-equipped microwave oven is provided with a sensor for detecting an object, in which a ventilation fan is controlled to operate when the sensor detects an object (see, for example, JP 2003-194380 A). This ventilation fan-equipped microwave oven is configured such that the operation mode of the ventilation fan is switched by a user holding his/her hand over the sensor, thereby improving the usability.

However, the ventilation fan-equipped microwave oven requires the user to operate the ventilation fan according to the state of cooking by holding his/her hand over the sensor, which disadvantageously results in poor convenience to the user.

Other conventional ventilation fan-equipped microwave ovens include one in which a temperature sensor is placed on a bottom plate to detect temperatures of the bottom plate and the ventilation fan is automatically controlled to operate when the temperature of the bottom plate increases high.

### CITATION LIST

### Patent Literature

PTL 1: JP 2003-194380 A

### SUMMARY OF INVENTION

### Technical Problem

The ventilation fan-equipped microwave oven that controls the ventilation fan using the temperature sensor, however, has the following problem. When cooking an object with a cooking gas stove at low heat or an 1H (induction heating) stove, namely an induction stove, installed on a cooking cabinet, the temperature rise of the object being cooked on the cooking cabinet may be suppressed, as compared with the case of cooking on high heat of the gas stove, and the temperature detected by the temperature sensor may not be high enough to cause the ventilation fan to be operated. In such a case, the ventilation fan needs to be manually operated, and hence convenience is lowered accordingly.

Thus, an object of the present invention is to provide ventilation fan-equipped microwave ovens capable of accurately controlling the ventilation fan on the basis of a detection result of an infrared sensor, and a cooking system equipped with the same.

### Solution to Problem

In order to solve the above problem, a ventilation fan-equipped microwave oven according to an aspect of the present invention includes:

a housing to be disposed above a cooking cabinet;

a main body disposed in the housing;

an intake port provided on a lower side of the housing;

a duct disposed in the housing, the duct leading from the intake port to a discharge port,

a ventilation fan disposed in the housing to cause air sucked through the intake port to circulate though the duct and be discharged outside through the discharge port;

an infrared sensor disposed on the lower side of the housing to detect temperatures of an object on the cooking cabinet; and

a control unit configured to control the ventilation fan based on the temperatures, detected by the infrared sensor, of the object on the heating cooking cabinet.

### Advantageous Effects of Invention

As is apparent from the above, according to the present invention, it is possible to realize ventilation fan-equipped microwave ovens in which the ventilation fan is accurately controlled on the basis of the detection result of the infrared sensor.

Also, according to the present invention, it is possible to realize cooking systems equipped with a ventilation fan-equipped microwave oven in which the ventilation fan is accurately controlled on the basis of the detection result of the infrared sensor.

### BRIEF DESCRIPTION OF DRAWINGS

FIG. 1A is a front view of a cooking system including a ventilation fan-equipped microwave oven according to a first embodiment of the present invention;

FIG. 1B is a top view of a cooking cabinet;

FIG. 2 is a schematic front view of the ventilation fan-equipped microwave oven;

FIG. 3 is a schematic bottom view of the ventilation fan-equipped microwave oven;

FIG. 4 is a schematic top view of the ventilation fan-equipped microwave oven;

FIG. 5 is a schematic cross sectional view of the ventilation fan-equipped microwave oven;

FIG. 6 is a control block diagram of the ventilation fan-equipped microwave oven; and

FIG. 7 is a control block diagram of a ventilation fan-equipped microwave oven according to a second embodiment of the present invention.

### DESCRIPTION OF EMBODIMENTS

Embodiments of the ventilation fan-equipped microwave oven according to the present invention and the cooking system equipped with the same will be described below referring to the attached drawings

### First Embodiment

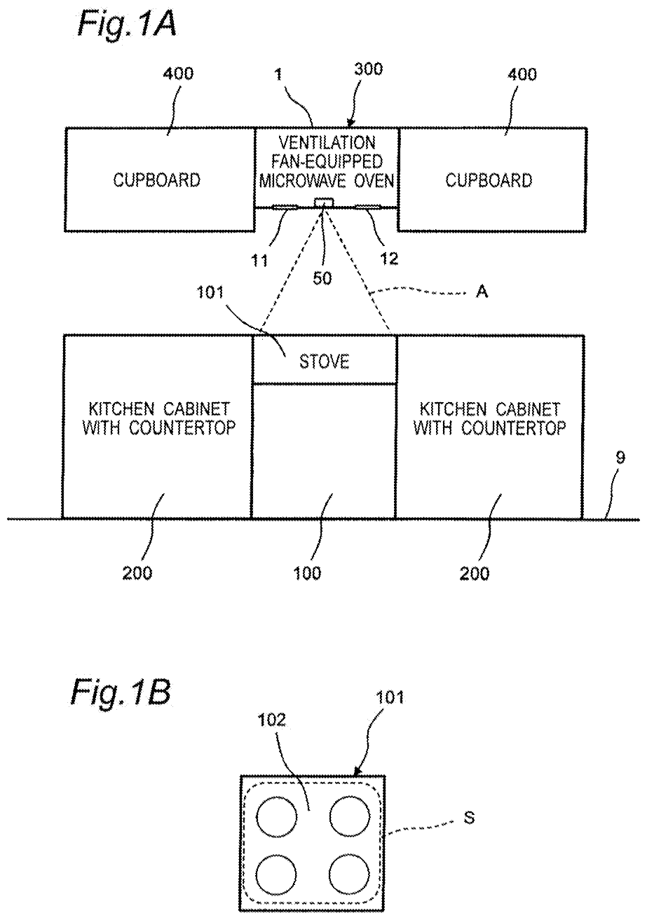

FIG. 1A shows a front view of a cooking system having a ventilation fan-equipped microwave oven according to a first embodiment of the present invention.

As shown in FIG. 1A, the cooking system of the first embodiment has a cooking cabinet 100 installed on a floor 9, two kitchen cabinets with countertop 200, 200 installed on the floor 9 on both sides of the cooking cabinet 100, a ventilation fan-equipped microwave oven (simply referred to as “microwave oven” below) 300 installed above the cooking cabinet 100, and cupboards 400, 400 installed on both sides of the microwave oven 300. An induction stove 101 is mounted on top of the cooking cabinet 100.

The cooking cabinet 100, the kitchen cabinets with countertop 200, 200, the microwave oven 300, and the cupboards 400, 400 are arranged with their backs against a wall.

The microwave oven 300 has an infrared sensor 50 mounted on a bottom side of the housing 1 for detecting temperatures of an object or objects to be heated or being heated on the cooking cabinet 100. A region A indicated by dotted lines in FIG. 1A shows a detection field range of the infrared sensor 50.

FIG. 1B shows a top view of the cooking cabinet 100. A region S surrounded by dotted line in FIG. 1B is a region for a cooktop 102 of the induction stove 101.

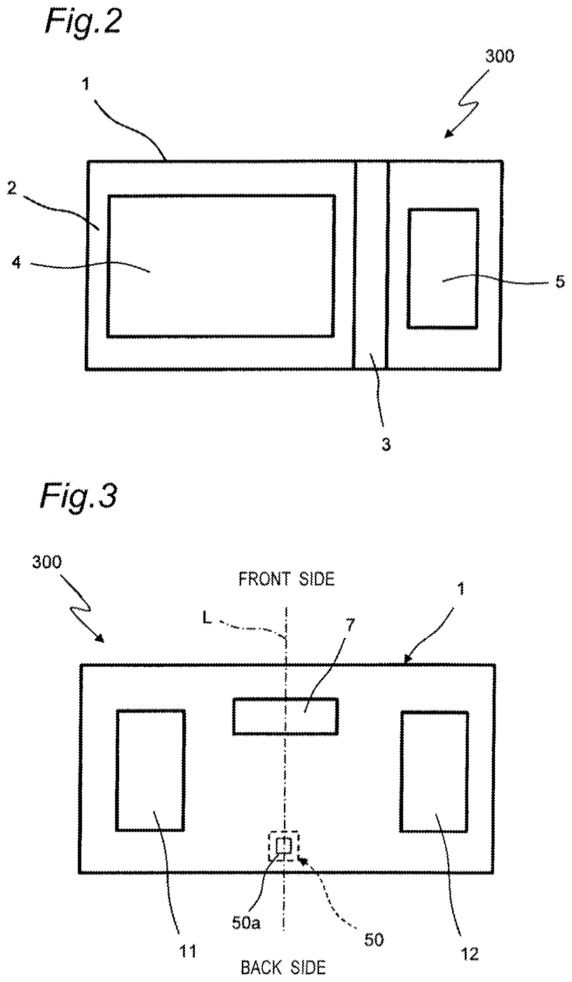

FIG. 2 is a schematic front view of the microwave oven 300.

The microwave oven 300 has a heating chamber (not shown) provided in the housing 1 of a rectangular parallelepiped shape that is arranged above the cooking cabinet 100. The microwave oven 300 also has a door 2 over a front opening of the heating chamber. The door 2 rotates around a left-hand side of the door. The door 2 has a handle 3 and a heat-resistant door glass panel 4. An operation panel 5 is provided on a right-hand side of the door 2.

FIG. 3 is a schematic bottom view of the microwave oven 300. A left intake port 11 and a right intake port 12 are provided, laterally spaced from each other, in the bottom of the housing 1. The right and left intake ports 12 and 11 are open toward the cooking cabinet 100 below.

The infrared sensor 50 is disposed on the bottom surface of the housing in a rear position (near the kitchen wall) on a straight line L passing in the fore-and-aft direction of the housing 1 between the right and left intake ports 12 and 11. In FIG. 3, 7 denotes illumination unit, and 50a denotes a detection surface of the infrared sensor 50.

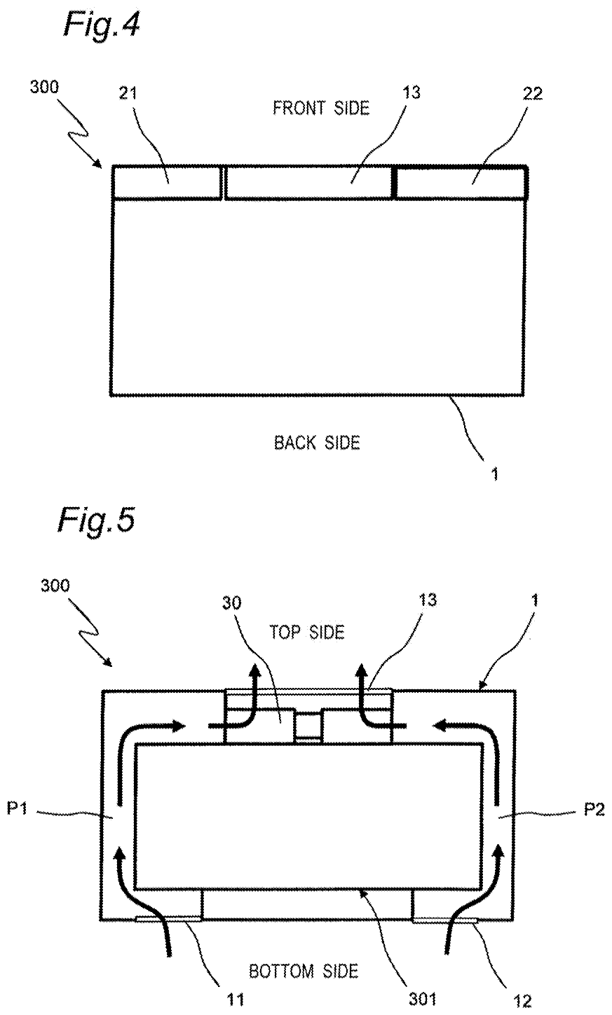

FIG. 4 is a schematic top view of the microwave oven 300. The microwave oven 300 has a discharge port 13 in a central position of an upper front part of the housing 1, through which port air sucked through the right and left intake ports 12 and 11 is discharged. Also, provided on both sides of the discharge port 13 are additional discharge ports 21, 22 for discharging cooling air from a main body 301 of the microwave oven (shown in FIG. 5).

FIG. 5 is a schematic cross sectional view of the microwave oven 300.

The main body 301 of the microwave oven 300 is disposed in the housing 1. Also, ducts P1 and P2 leading from the left intake port 11 and the right intake port 12 to the discharge port 13, respectively, are arranged in the housing.

Also, provided in an upper position in the housing is a ventilation fan 30 that makes air sucked through the left intake port 11 and the right intake port 12 circulate through the ducts P1, P2 to the discharge port 13 through which the air is discharged outside.

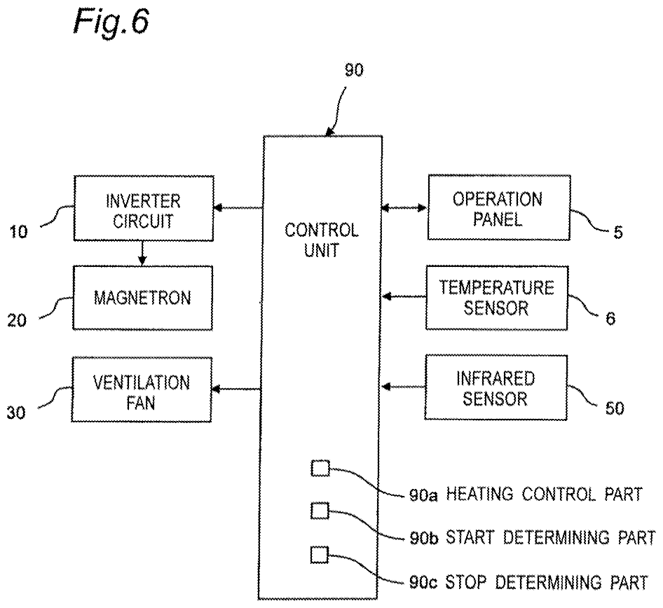

FIG. 6 is a control block diagram of the microwave oven 300. The microwave oven 300 has a control unit 90 including a microcomputer, an input/output circuit, etc.

Connected to the control unit 90 are the operation panel 5, a temperature sensor 6 for detecting temperatures in the heating chamber, an inverter circuit 10 configured to drive the magnetron 20, the ventilation fan 30, the infrared sensor 50 for detecting temperatures of an object or objects to be heated/being heated/having been heated (simply referred to as “the object” below) on the cooking cabinet 100.

The control unit 90 has a heating control part 90a for controlling the inverter circuit 10 to drive the magnetron 20, a start determining part 90b for determining whether or not a temperature, detected by the infrared sensor 50, of the object on the cooking cabinet 100 is equal to or higher than a start determination temperature, and a stop determining part 90c for determining whether or not a temperature, detected by the infrared sensor 50, of the object on the cooking cabinet 100 is equal to or lower than a stop determination temperature.

When the start determining part 90b determines that the detected temperature of the object on the cooking cabinet 100 is equal to or higher than the start determination temperature, the control unit 90 causes the ventilation fan 30 to start operating.

When the stop determining part 90c determines that the detected temperature of the object on the cooking cabinet 100 is equal to or lower than the stop determination temperature, the operation of the ventilation fan 30 is stopped by the control unit 90.

In this microwave oven, the control unit 90 is configured to control the volume of air during operation of the ventilation fan 30, based on temperatures, detected by the infrared sensor 50, of the object on the cooking cabinet 100. For example, the rotation speed of the ventilation fan 30 may be controlled such that as the temperature of the object on the cooking cabinet 100 increases, the volume of air of the fan increases continuously or in a stepwise fashion.

According to the ventilation fan-equipped microwave oven with the above configuration, the ventilation fan 30 is controlled by the control unit 90 based on temperatures, detected by the infrared sensor 50, of the object on the cooking cabinet 100. This allows temperatures of the object on the cooking cabinet 100 to be accurately determined, which in turn makes it possible to properly and accurately control the ventilation fan 30. Even when cooking with the induction stove 101, in which case the temperature of the object on the cooking cabinet 100 does not increase compared with the case of cooking on high heat of a gas stove, use of the infrared sensor 50 makes it possible to accurately determine the temperature of the object on the cooking cabinet 100 and operate the ventilation fan 30 accordingly. As a result, the user does not need to manually control the ventilation fan 30, and convenience is greatly improved.

The infrared sensor 50 is disposed on the bottom surface of the housing 1 of the microwave oven and between the right and left intake ports 12 and 11. This position of the infrared sensor 50 prevents heated air and steam above the cooking cabinet 100 being sucked into the right and left intake ports 12 and 11 from hindering the detection operation of the infrared sensor 50. Thus, the temperature of the object on the cooking cabinet 100 can be detected accurately.

The control unit 90 causes the operation of the ventilation fan 30 to be started when the start determining part 90b determines that the temperature of the object on the cooking unit 100 is equal to or higher than the start determination temperature. In this way, the ventilation fan 30 is automatically operated.

The control unit 90 causes the operation of the ventilation fan 30 to be stopped when the stop determining part 90c determines that the temperature of the object on the cooking unit 100 is equal to or higher than the stop determination temperature. In this way, the ventilation fan 30 is automatically stopped operating.

Detection of temperatures is carried out for objects that are present within the region S (shown in FIG. 1B) of the cooktop 102 on the cooking cabinet 100. This prevents the ventilation fan 30 from malfunctioning by the influence of high-temperature objects such as pans or pots placed outside of the region S.

The above arrangement achieves a cooking system having the microwave oven 300 with the ventilation fan 30 which is accurately controllable based on the detection results of the infrared sensor 50.

In this first embodiment, the microwave oven 300 is provided with the right and left intake ports 12 and 11 in the bottom surface of the housing 1, laterally spaced from each other. Alternatively, three or more intake ports may be provided. Also, the intake ports may be of a circular shape, an oval shape, or a polygonal shape.

Further, in the first embodiment, the infrared sensor 50 is described as being disposed on the bottom surface of the housing 1 in a rear position (near the kitchen wall) on a straight line L passing in the fore-and-aft direction of the housing L between the right and left intake ports 12 and 11. Alternatively, the infrared sensor 50 may be disposed in a front position on the straight line L. The position on the bottom surface of the housing of the microwave oven in which the sensor 50 should be placed is not limited to the above, but may be any position in which detection by the infrared sensor is not (or hardly) affected by hot air and/or steam flowing into the intake ports.

Furthermore, the control function for the ventilation fan 30 may be provided to another controller for the ventilation fan different from the control unit 90.

### Second Embodiment

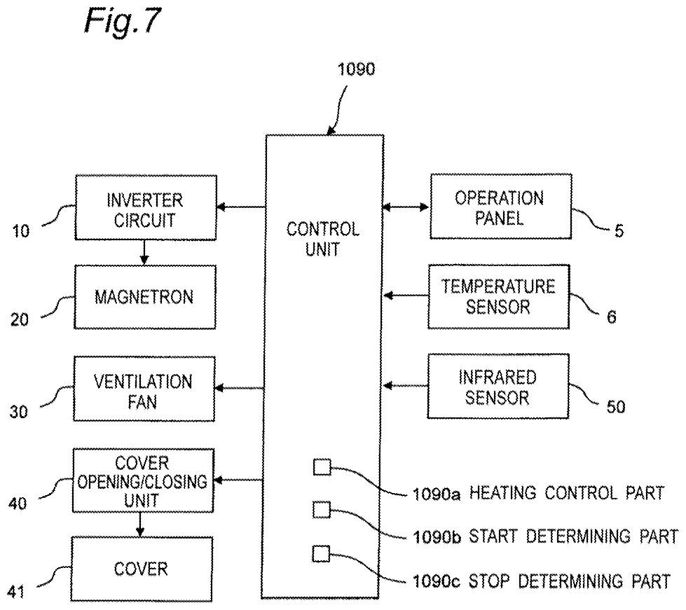

FIG. 7 shows a control block diagram of a ventilation fan-equipped microwave oven (referred to simply as “microwave oven” below” according to a second embodiment of the present invention. The structure of the microwave oven according to the second embodiment is same as that of the microwave oven according to the first embodiment, except for a cover opening/closing part. Therefore, FIGS. 1A, 1B through FIG. 5 are also used for the second embodiment.

The microwave oven has the cover 41 which covers the detection surface 50a (shown in FIG. 1B), and a cover opening/closing unit 40.

Connected to the control unit 1090 are the operation panel 5, the temperature sensor 6 for detecting the temperature in the heating chamber, the inverter circuit 10 configured to drive the magnetron 20, the ventilation fan 30, the cover opening/closing unit or mechanism 40 for opening and closing the cover 41, the infrared sensor 50 for detecting temperatures of an object or objects to be heated/being heated/heated (simply referred to as “the object” below) on the cooking cabinet 100.

The control unit 1090 has a heating control part 1090a for controlling the inverter circuit 10 to drive the magnetron 20, a start determining part 1090b for determining whether or not a temperature, detected by the infrared sensor 50, of the object on the cooking cabinet 100 is equal to or higher than a start determination temperature, and a stop determining part 1090c for determining whether or not a temperature, detected by the infrared sensor 50, of the object on the cooking cabinet 100 is equal to or lower than a stop determination temperature.

When the start determining part 1090b determines that the detected temperature of the object on the cooking cabinet 100 is equal to or higher than the start determination temperature, the ventilation fan 30 is started operating by the control unit 1090.

When the stop determining part 1090c determines that the detected temperature of the object on the cooking cabinet 100 is equal to or lower than the stop determination temperature, the operation of the ventilation fan 30 is stopped by the control unit 1090.

According to the microwave oven with the arrangement and configuration described above, the cover 41 for covering the detection surface 50a of the infrared sensor 50 is closed or opened by the cover opening/closing unit 40 that is controlled by the control device 1090. Thus, when the infrared sensor 50 is not required to perform the detection operation during cooking, the cover 41 may be closed, which prevents the detection surface of the infrared sensor 50 from being soiled.

The control unit 1090 causes the cover 41 to be intermittently opened at predetermined intervals during the operation of the ventilation fan 30 to allow the infrared sensor 50 to detect temperatures of the object on the cooking cabinet 100. Then, when the stop determining part 1090c determines that a detected temperature of the object on the cooking cabinet 100 is equal to or lower than the stop determination temperature, the operation of the ventilation fan 30 is stopped and the cover 41 is closed, under control of the control unit 1090. Such closure of the cover 41 for the ventilation fan 30 during the cooking allows the detection surface of the infrared sensor 50 to be prevented from being soiled. On the other hand, the intermittent opening of the cover 41 allows the infrared sensor 50 to detect temperatures of the object on the cooking cabinet 100, so that it can be determined whether the operation of the ventilation fan 30 should be stopped or not.

The second embodiment has the cover 41 for covering the detection surface 50a of the infrared sensor 50 and the cover opening/closing unit 40 for opening and closing the cover 41. The detection surface 50a of the infrared sensor 50 may be covered with glass that transmits infrared rays.

### Third Embodiment

A ventilation fan-equipped microwave oven according to a third second embodiment of the invention has the same structure as that of the microwave oven according to the first embodiment, except for the infrared sensor 50 and operation of the control unit 90. Therefore, FIGS. 1A, 1B through FIG. 5 are also used for the second embodiment.

The microwave oven of the third embodiment uses an area sensor capable of detecting a plurality of areas as the infrared sensor 50.

In this microwave oven, the control unit 90 obtains temperatures of the plurality of areas on the cooking cabinet 100 detected by the infrared sensor 50. This arrangement makes it possible to detect which of burners, i.e., cooking zones, of the induction stove 101 has/have an increased temperature. The control unit 90 controls the air volume of the ventilation fan 30 depending on the temperatures of the burners detected by the infrared sensor 50, whereby efficient ventilation is achievable.

The microwave oven may be provided with ventilation fans for a respective one of the right and left intake ports 12, 11, in which arrangement it is possible to operate only one of these ventilation fans depending on the temperatures, detected by the infrared sensor 50, of each burner of the stove. As a result, more efficient ventilation operation can be achieved.

In the third embodiment, if it is detected, based on the temperatures, detected by the infrared sensor 30, of the burners of the stove that a particular burner of the stove has an abnormally high temperature, then an alarm may be output by voice or display indicating which burner of the stove has high-temperature abnormality.

Cooking systems including a ventilation fan-equipped microwave oven according to the present invention are not limited to the ones of the first to third embodiments, but the present invention is applicable to cooking systems of different structure as far as the ventilation fan-equipped microwave oven included in the cooking systems is installed above the cooking cabinet equipped with an induction cooktop.

Specific embodiments of the present invention have been described above, but the present invention is not limited to the foregoing first to third embodiments and various modifications may be made without departing from the scope of the present invention. For example, an embodiment of the present invention may be made by combining features described in the foregoing first to third embodiments as appropriate.

The present invention and the embodiments thereof are summarized as follows.

A ventilation fan-equipped microwave oven according to an aspect of the present invention includes:

a housing 1 to be disposed above a cooking cabinet 100;

a main body 301 disposed in the housing 1;

an intake port 11, 12 provided on a lower side of the housing 1;

a duct P1, P2 disposed in the housing 1, the duct P1, P2 leading from the intake port 11, 12 to a discharge port,

a ventilation fan 30 disposed in the housing 1 to cause air sucked through the intake port 11, 12 to circulate though the duct P1, P2 and be discharged outside through the discharge port;

an infrared sensor 50 disposed on the lower side of the housing 1 to detect temperatures of an object on the cooking cabinet 100; and

a control unit 90, 1090 configured to control the ventilation fan 30 based on the temperatures, detected by the infrared sensor 30, of the object on the cooking cabinet 100.

With the above arrangement, the ventilation fan 30 is controlled by the control unit 90, 1090 based on temperatures, detected by the infrared sensor 50, of the object on the cooking cabinet 100. This allows temperatures of the object on the cooking cabinet 100 to be accurately determined, which in turn makes it possible to properly and accurately control the ventilation fan 30. For example, when cooking with the induction stove 101, in which case the temperature of the object on the cooking cabinet 100 may not increase compared with the case of cooking on high heat of a gas stove, use of the infrared sensor 50 makes it possible to accurately determine the temperature of the object on the cooking cabinet 100 and operate the ventilation fan 30 accordingly. As a result, the user does not need to manually control the ventilation fan 30, and convenience is greatly improved.

In one embodiment, the intake port 11, 12 comprises a right intake port 12 and a left intake port 11 provided in a bottom surface of the housing 1, spaced from each other in a lateral direction of the housing 1, and the infrared sensor 50 is disposed on the bottom surface of the housing 1 and between the right intake port 12 and the left intake port 11.

According to the embodiment, disposing the infrared sensor 50 on the bottom surface of the housing 1 and between the right and left intake ports 12, 11 prevents heated air and steam above the cooking cabinet 100 being sucked into the right and left intake ports 12, 11 from hindering the detection by the infrared sensor 50. Thus, the temperature of the object on the cooking cabinet 100 can be detected accurately.

In one embodiment, the control unit 90, 1090 has a start determining part 90b, 1090b for determining whether or not a temperature, detected by the infrared sensor 50, of an object on the cooking cabinet 100 is equal to or higher than a preset start determination temperature, and when the start determining part 90b, 1090b determines that the detected temperature of the object on the cooking cabinet 100 is equal to or higher than the start determination temperature, the control unit 90, 1090 causes the ventilation fan 30 to start operating.

According to the embodiment, the control unit 90, 1090 causes the operation of the ventilation fan 30 to be started when the start determining part 90b, 1090b determines that the temperature of the object on the cooking unit 100 is equal to or higher than the start determination temperature. In this way, the ventilation fan 30 is automatically operated.

In one embodiment, the ventilation fan-equipped microwave oven further includes a cover 41 for covering at least a detection surface of the infrared sensor 50, and a cover opening/closing unit 40 controlled by the control unit 1090 to open or close the cover 41.

According to the embodiment, the cover 41 for covering the detection surface 50a of the infrared sensor 50 is closed or opened by the cover opening/closing unit 40 that is controlled by the control device 1090. Thus, when the infrared sensor 50 is not required to perform the detection operation during cooking, the cover 41 may be closed, which prevents the detection surface of the infrared sensor 50 from being soiled.

In one embodiment, the ventilation fan-equipped microwave oven further includes a cover 41 for covering at least a detection surface of the infrared sensor 50, and a cover opening/closing unit 40 controlled by the control unit 1090 to open or close the cover 41, wherein the control unit 1090 has a stop determining part 1090c for determining whether or not a temperature, detected by the infrared sensor 50, of an object on the cooking cabinet 100 is equal to or lower than a preset stop determination temperature, the control unit 1090 causes the cover 41 to be intermittently opened at predetermined intervals during operation of the ventilation fan 30 to allow the infrared sensor 50 to detect temperatures of the object on the cooking cabinet 100, and when the stop determining part 1090c determines that a detected temperature of the object on the cooking cabinet 100 is equal to or lower than the stop determination temperature, the control unit 1090 causes the operation of the ventilation fan 30 to be stopped.

According to the embodiment, the control unit 1090 causes the cover 41 to be intermittently opened at predetermined intervals during the operation of the ventilation fan 30 to allow the infrared sensor 50 to detect temperatures of the object on the cooking cabinet 100. Then, when the stop determining part 1090b determines that a detected temperature of the object on the cooking cabinet 100 is equal to or lower than the stop determination temperature, the operation of the ventilation fan 30 is stopped and the cover 41 is closed, under control of the control unit 1090. Such closure of the cover 41 for the ventilation fan 30 during the cooking allows the detection surface of the infrared sensor 50 to be prevented from being soiled. On the other hand, the intermittent opening of the cover 41 allows the infrared sensor 50 to detect temperatures of the object on the cooking cabinet 100, so that it can be determined whether the operation of the ventilation fan 30 should be stopped or not.

In one embodiment, the infrared sensor 50 detects temperatures of an object that is present within a region of a cooktop 102 on the cooking cabinet.

According to the embodiment, detection of temperatures is carried out for objects that are present within the region S (shown in FIG. 1B) of the cooktop 102 on the cooking cabinet 100. This prevents the ventilation fan 30 from malfunctioning by the influence of high-temperature objects such as pans or pots placed outside of the region S.

A cooking system according to another aspect of the present invention includes a cooking cabinet 100 having an induction cooktop, and the above-described ventilation fan-equipped microwave oven 300, which is installed above the cooking cabinet 100.

The above arrangement achieves a cooking system having the microwave oven 300 with the ventilation fan 30 which is accurately controllable based on the detection results of the infrared sensor 50.

### REFERENCE SIGNS LIST

1: housing
2: door
3: handle
4: door glass panel
5: operation panel
6: temperature sensor
7: illumination unit
9: floor
11: left intake port
12: right intake port
13: discharge port
21, 22: discharge port
20: magnetron
30: ventilation fan
40: cover opening/closing unit
41: cover
50: infrared sensor
90, 1090: control unit
90a, 1090a: heating control part
90b, 1090b: start determining part
90c, 1090c: stop determining part
100: cooking cabinet
101: induction stove
102: cooktop
200: kitchen cabinet with countertop
300: ventilation fan-equipped microwave oven
301: main body of the microwave oven
400: cupboard

1. A ventilation fan-equipped microwave oven comprising:
a housing to be disposed above a cooking cabinet;
a main body disposed in the housing;
an intake port provided on a lower side of the housing;
a duct disposed in the housing, the duct leading from the intake port to a discharge port,
a ventilation fan disposed in the housing to cause air sucked through the intake port to circulate though the duct and be discharged outside through the discharge port;
an infrared sensor disposed on the lower side of the housing to detect temperatures of an object on the cooking cabinet; and
a control unit configured to control the ventilation fan based on the temperatures, detected by the infrared sensor, of the object on the cooking cabinet.

2. The ventilation fan-equipped microwave oven according to claim 1, wherein
the intake port comprises a right intake port and a left intake port provided in a bottom surface of the housing, spaced from each other in a lateral direction of the housing, and
the infrared sensor is disposed on the bottom surface of the housing and between the right intake port and the left intake port.

3. The ventilation fan-equipped microwave oven according to claim 1, wherein
the control unit has a start determining part for determining whether or not a temperature, detected by the infrared sensor, of an object on the cooking cabinet is equal to or higher than a preset start determination temperature, and
when the start determining part determines that the detected temperature of the object on the cooking cabinet is equal to or higher than the start determination temperature, the control unit causes the ventilation fan to start operating.

4. The ventilation fan-equipped microwave oven according to claim 1, further comprising:
a cover for covering at least a detection surface of the infrared sensor; and
a cover opening/closing unit controlled by the control unit to open or close the cover.

5. The ventilation fan-equipped microwave oven according to claim 1, further comprising:
a cover for covering at least a detection surface of the infrared sensor; and
a cover opening/closing unit controlled by the control unit to open or close the cover, wherein
the control unit has a stop determining part for determining whether or not a temperature, detected by the infrared sensor, of an object on the cooking cabinet is equal to or lower than a preset stop determination temperature,
the control unit causes the cover to be intermittently opened at predetermined intervals during operation of the ventilation fan to allow the infrared sensor to detect temperatures of the object on the cooking cabinet, and
when the stop determining part determines that a detected temperature of the object on the cooking cabinet is equal to or lower than the stop determination temperature, the control unit causes the operation of the ventilation fan to be stopped.

6. The ventilation fan-equipped microwave oven according to claim 1, wherein
the infrared sensor detects temperatures of an object that is present within a region of a cooktop on the cooking cabinet.

7. A cooking system comprising:
a cooking cabinet having an induction cooktop; and
the ventilation fan-equipped microwave oven according to claim 1, which is installed above the cooking cabinet.
